(19) United States
(12) Patent Application Publication
(10) Pub. No.: US 2025/0233337 A1
(43) Pub. Date: Jul. 17, 2025

(54) HIGH DENSITY CONNECTOR WITH MOVEABLE CONTACTS

(71) Applicant: Sandisk Technologies, Inc., Milpitas, CA (US)

(72) Inventors: Dibin Gangadharan, Bangalore (IN); Tenzin Namgyal Maja, Bangalore (IN)

(21) Appl. No.: 18/410,569

(22) Filed: Jan. 11, 2024

(51) Int. Cl. H01R 13/24; H01R 13/502

(52) U.S. Cl. CPC H01R 13/24; H01R 13/502

(57) ABSTRACT

A high density connector for receiving an electronic component includes a housing, a first row of electrical contacts in a first plane and a second row of electrical contacts in a second plane. The second plane is above the first plane. The high density connector also includes a connector contact. When an edge connector of the electronic component is received in the housing, the edge connector contacts the connector contact. The connector contact rotates about an axis and moves the second row of electrical contacts from the second plane toward to the first plane. When the second row of electrical contacts is in the first plane, the second row of electrical contacts is electrically coupled to a second row of connection pins on the electronic component.

### BACKGROUND

A data storage device, such as a non-volatile data storage device, typically includes a connector that connects the data storage device to a host device. For example, a solid state drive (SSD) uses an edge connector to interface with a Peripheral Component Interconnect Express (PCIe) bus or other connector on a motherboard of the host device. The edge connector typically includes a first row of connection pins, or other contacts, on a first surface of the edge connector and a second row of connection pins, or other contacts, on a second surface of the edge connector opposite the first surface.

To accommodate more connection pins, some edge connectors include multiple rows of connection pins on each surface. For example, a first row of connection pins is positioned at a first location on the first surface and a second row of connection pins is positioned at a second location on the first surface.

However, there are a number of drawbacks to including multiple rows of connection pins on each surface. For example, the number of times the first row of connection pins is inserted into and past electrical contacts of a connector will be two times greater than the second row of connection pins, which decreases the durability of the first row of connection pins. Additionally, during hot insertion and removal, the first row of connection pins may contact electrical contacts in the connector that are meant for the second row of connection pins, which may cause shorts or other issues.

Another way to accommodate more connection pins is to increase a width of the edge connector. However, if the width of the edge connector is increased, the width of the corresponding PCIe connector on the motherboard of the host device must also be increased. Due to size constraints, increasing the width of the edge connector and/or the PCIe connector may not be desirable or possible.

Accordingly, it would be beneficial for a connector to accommodate edge connectors with high connection pin densities without increasing the width of the connector and reducing or eliminating the risk of shorts.

### SUMMARY

The present application describes a high density connector for an electronic device or an electronic component. In an example, the electronic device is a non-volatile storage device (e.g., a solid state drive (SSD)) or other data storage device. Although a data storage device is specifically mentioned, the high density connector described herein may be used to communicatively couple various electronic components and/or electronic devices to a host device.

The high density connector includes a housing and a first row of electrical contacts in a first plane or elevation and a second row of electrical contacts in a second plane or elevation. In an example, the second plane or elevation is higher than, or is above, the first plane or elevation. The first row of electrical contacts is stationary and is adapted or positioned to contact a first row of connection pins of an edge connector when the edge connecter is inserted into an opening of the high density connector. However, the second row of electrical contacts moves between a first position and a second position when the edge connector is inserted into the opening of the high density connector.

For example, when the edge connector is inserted into the opening of the high density connector, the inserted edge of the edge connector contacts a connector contact within the housing. As the edge connector is inserted further into the high density connector, the connector contact moves or pivots about an axis, which causes the second row of electrical contacts to move from the first position toward a second position. When the second row of electrical contacts are in the second position, the second row of electrical contacts contact a second row of connection pins on the edge connector.

Accordingly, examples of the present disclosure describe a connector having a first row of electrical contacts and a second row of electrical contacts. In an example, the first row of electrical contact is located on a first plane of the connector and the second row of electrical contacts are located on a second plane of the connector that is above the first plane. The connector also includes a connector contact. The connector contact causes the second row of electrical contacts to move from the second plane toward the first plane in response to an edge connector of an electronic component contacting a surface of the connector contact.

Other examples describe a high density connector for an electronic device. In an example, the high density connector includes a housing that defines an opening for receiving an edge connector of an electronic component. In an example, the edge connector has a first row of connection pins and a second row of connection pins behind the first row of connection pins. The high density connector also includes a first row of electrical contacts located at a first elevation within the housing and a second row of electrical contacts located at a second elevation within the housing. In an example, the second elevation is above the first elevation. The high density connector also includes a connector contact provided within the housing. The connector contact is moveable between a first position and a second position. In an example, the second row of electrical contacts moves from the second elevation toward the first elevation in response to the connector contact moving from the first position to the second position.

Still other examples describe a connector that includes a first row of contact means having a first elevation and a second row of contact means having a second elevation that is greater than the first elevation. The connector also includes a contact row pivoting means that causes the second row of contact means to move from a first position to a second position in response to an edge connector of an electronic component being inserted into an opening defined by the connector.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1A illustrates a side cross-section view of a high density connector according to an example.

FIG. 1B illustrates a front cross-section view of the high density connector shown and described with respect to FIG. 1A according to an example.

FIG. 2A illustrates a first side of an electronic component having a first row of connection pins on an edge connecter and a second row of connection pins on the edge connector according to an example.

FIG. 2B illustrates a second side of the electronic component of FIG. 2A having a third row of connection pins on the edge connecter and a fourth row of connection pins on the edge connector according to an example.

FIG. 3A illustrates a side cross-section view of the electronic component of FIG. 2A being partially inserted into the high density connector of FIG. 1A according to an example.

FIG. 3B illustrates a side cross-section view of the electronic component of FIG. 2A being fully inserted into the high density connector of FIG. 1A according to an example.

FIG. 3C illustrates a front cross-section view of the electronic component of FIG. 2A being fully inserted into the high density connector of FIG. 1A according to an example.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. The following detailed description is therefore not to be taken in a limiting sense, and the scope of the present disclosure is defined by the appended claims and their equivalents.

Electronic devices or electronic components, such as data storage devices, typically include a connector (e.g., an edge connector) that connects the electronic device to a host device. For example, an edge connector of a data storage device is typically used to connect the data storage device to a Peripheral Component Interconnect Express (PCIe) bus or other connector on a motherboard of the host device. The edge connector typically includes a first row of connection pins, or other contacts, on a first surface and a second row of connection pins, or other contacts, on a second surface that is opposite the first surface.

However, connection pin density of the edge connector is limited. As previously explained, in order to accommodate more connection pins, some edge connectors include multiple rows of connection pins on each surface. For example, a first row of connection pins is positioned at a first location on the first surface and a second row of connection pins is positioned at a second location on the first surface.

There are a number of drawbacks to including multiple rows of connection pins on each surface. For example, the number of times the first row of connection pins is inserted into and past electrical contacts of a connector will be two times greater than the second row of connection pins. This decreases the durability of the first row of connection pins. Additionally, during hot insertion and removal, the first row of connection pins may contact electrical contacts in the connector that are meant for the second row of connection pins which may cause shorts or other issues.

Another way to accommodate more connection pins is to increase a width of the edge connector. However, if the width of the edge connector is increased, the width of the corresponding PCIe connector on the motherboard of the host device must also be increased. Due to size constraints, increasing the width of the edge connector and/or the PCIe connector may not be desirable or possible.

To address the drawbacks described above, the present application describes a high density connector for an electronic device or an electronic component. The high density connector has one or more moveable rows of electrical contacts and one or more rows of stationary electrical contacts. For example, the connector includes a housing and a first row of electrical contacts in a first plane or elevation and a second row of electrical contacts in a second plane or elevation. In an example, the second plane or elevation is higher than, or is above, the first plane or elevation.

The first row of electrical contacts is stationary and is adapted and/or positioned to contact a first row of connection pins of an edge connector of an electronic component when the edge connecter is inserted into an opening of the high density connector. However, the second row of electrical contacts moves between a first position and a second position when the edge connector is inserted into the opening of the high density connector.

For example, when the edge connector is inserted into the opening of the high density connector, the inserted edge of the edge connector contacts a connector contact within the housing. As the edge connector is inserted further into the high density connector, the connector contact moves or pivots about an axis, which causes the second row of electrical contacts to move from the first position toward a second position. When the second row of electrical contacts are in the second position, the second row of electrical contacts contact a second row of connection pins on the edge connector.

The high density connector described herein provides many technical benefits including, but not limited to, providing support for additional connection pins of an edge connector without increasing a width of the edge connector and/or a width of the high density connector. Additionally, an increase in the number of connection pins and electrical contacts increases the data transmission rate of the electronic component. The signal quality of the signals passed between the electronic component and the host device increases because additional ground pins may be added and provisions may be grouped without increasing signal congestion. The lifetime of the connection pins on the edge connector is also increased. Additionally, there is no pinout mapping restriction for the multiple rows of connection pins on the edge connector because the unwanted initial contact on the second row of electrical contacts is eliminated.

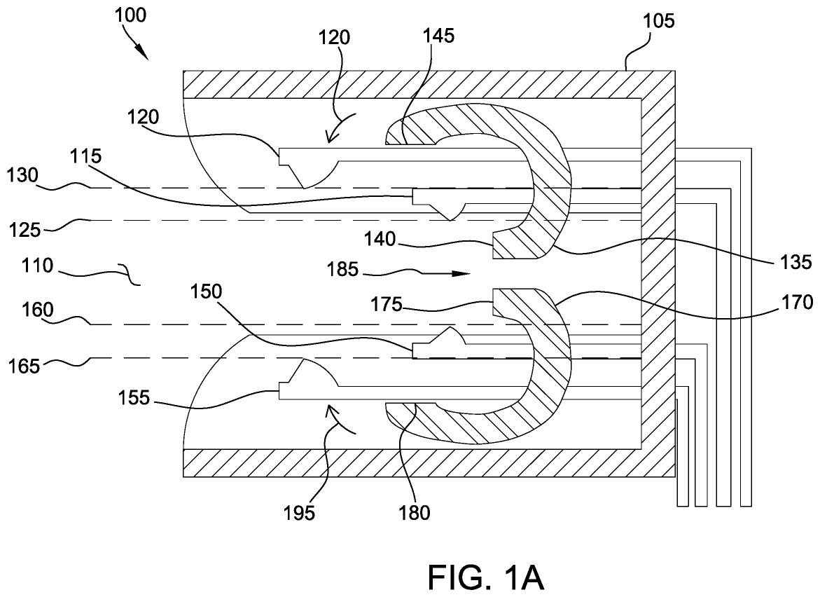

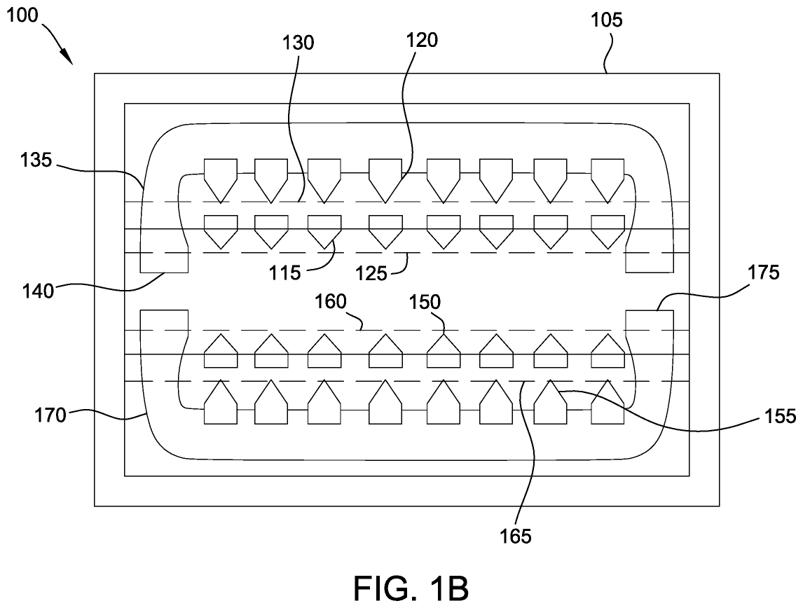

These and other benefits will be described in greater detail below with respect to FIG. 1A-FIG. 3C.

FIG. 1A illustrates a side cross-section view of a high density connector 100 according to an example. In an example, the high density connector 100 is adapted to receive or otherwise be electrically coupled to an electronic device or an electronic component. In an example, the electronic component is a non-volatile storage device (e.g., a solid state drive (SSD)) or other data storage device. Although a data storage device is specifically mentioned, the high density connector described herein may be used to communicatively couple various electronic components and/or electronic devices to a host device.

The high density connector 100 includes a housing 105. The housing 105 defines an opening 110 that receives the edge connector of the electronic component. The high density connector 100 also includes a first row of electrical contacts 115 and a second row of electrical contacts 120.

In an example, the first row of electrical contacts 115 extend a first distance within the housing 105 such that the first row of electrical contacts 115 will contact a first row of connection pins on the edge connector of the electronic component. Likewise, the second row of electrical contacts 120 extend a second distance within the housing 105 such that the second row of electrical contacts 120 will contact a second row of connection pins on the edge connector of the electronic component.

In an example, the first row of electrical contacts 115 is positioned at a first elevation or a first plane (represented by the dashed line 125) and the second row of electrical contacts 120 is positioned at a second elevation or a second plane (represented by the dashed line 130). As shown in FIG. 1A, the second elevation is above (or is higher than) the first elevation.

The high density connector 100 also includes a first connector contact 135. In an example, the first connector contact 135 is circular or rounded in shape and includes a first contact point 140 and a second contact point 145. Although a circular or a round shape is specifically shown and described, other shapes or configurations may be used.

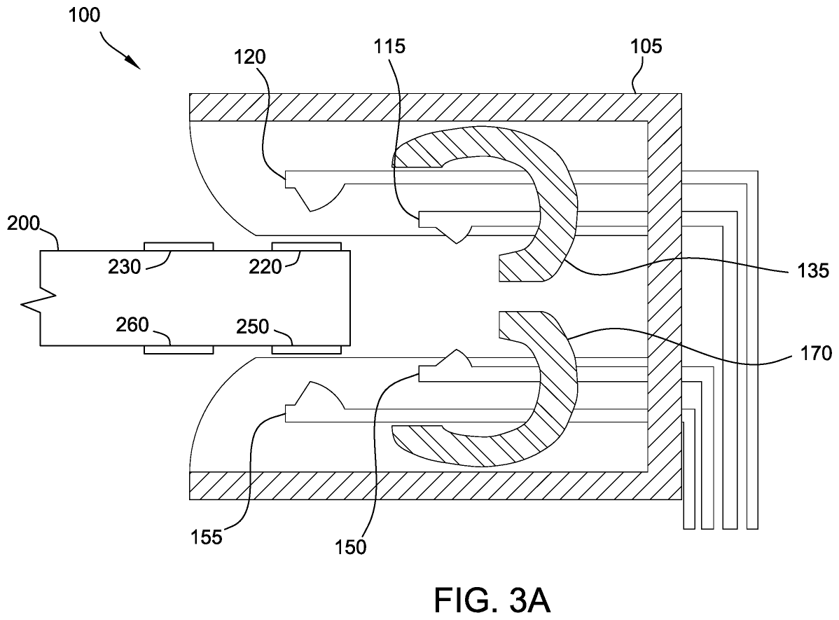

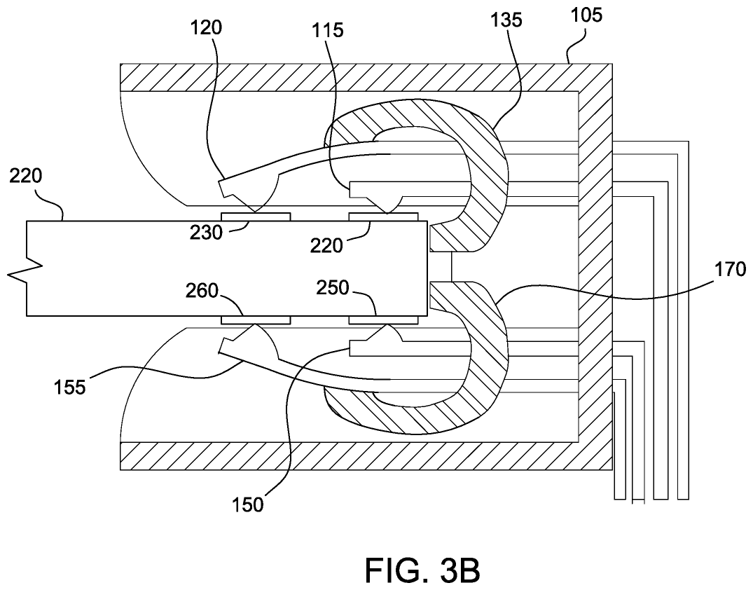

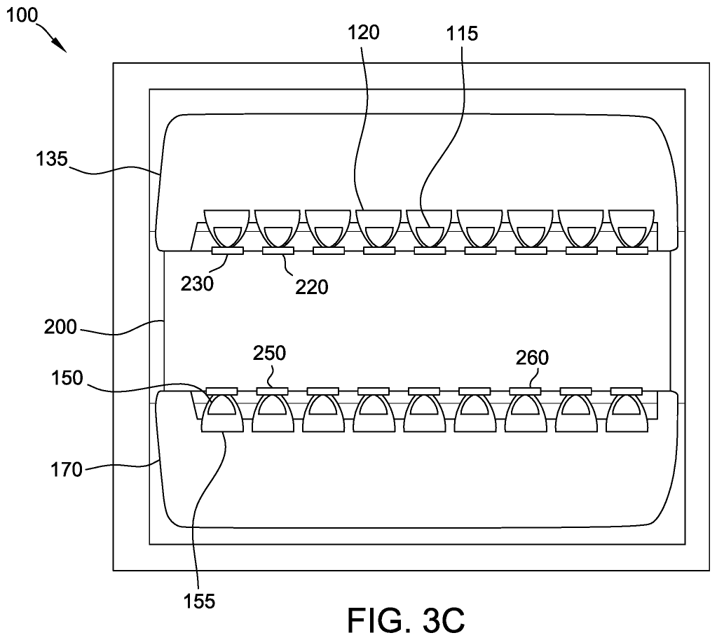

The connector contact 135 is rotatable or moveable about an axis from a first position/orientation (such as shown in FIG. 1A) to a second position/orientation (such as shown in FIG. 3B). As the connector contact 135 moves or rotates from the first position to the second position, the connector contact 135 causes the second row of electrical contacts 120 to move from a first position (e.g., a position in which each electrical contact of the second row of electrical contacts 120 are in the second plane) toward a second position (e.g., a position in which each electrical contact of the second row of electrical contacts 120 are in, or move toward, the first plane).

The high density connector 100 also includes a third row of electrical contacts 150 and a fourth row of electrical contacts 155. Like the first row of electrical contacts 115, the third row of electrical contacts 150 extend a third distance within the housing 105 such that the third row of electrical contacts 150 will contact a third row of connection pins on the edge connector of the electronic component. Likewise, the fourth row of electrical contacts 155 extend a fourth distance within the housing 105 such that the fourth row of electrical contacts 155 will contact a fourth row of connection pins on the edge connector of the electronic component.

In an example, the third row of electrical contacts 150 is positioned at a third elevation or a third plane (represented by the dashed line 160) and the fourth row of electrical contacts 155 is positioned at a fourth elevation or a fourth plane (represented by the dashed line 165). As shown in FIG. 1A, the fourth elevation is beneath (or is lower than) the third elevation.

The high density connector 100 also includes a second connector contact 170. In an example, the second connector contact 170 is similar to the first connector contact 135. For example, the second connector contact 170 is circular or rounded and includes a first contact point 175 and a second contact point 180.

The second connector contact 170 is rotatable or moveable about an axis from a first position/orientation (such as shown in FIG. 1A) to a second position/orientation (such as shown in FIG. 3B). As the second connector contact 170 moves or rotates from the first position to the second position, the second connector contact 170 causes the fourth row of electrical contacts 155 to move from a first position (e.g., a position in which each electrical contact of the fourth row of electrical contacts 155 are in the fourth plane) toward a second position (e.g., a position in which each electrical contact of the fourth row of electrical contacts 155 are in, or move toward, the third plane 125).

For example, when the edge connector of the electronic component is inserted into the opening 110 of the housing 105 (e.g., in the direction of the arrow 185), a sidewall or an edge of the edge connector contacts the first contact point 140 of the first connector contact 135 and contacts the first contact point 175 of the second connector contact 170. In example, the sidewall of the edge connector contacts each contact point simultaneously. In another example, the edge connector contacts the first connector contact 135 when the edge connector is inserted a first distance into the connector 100 and contacts the second connector contact 170 when the edge connector is inserted a second distance into the connector 100.

In an example, when the second row of electrical contacts 120 and the fourth row of electrical contacts 155 are in their respective first positions, the rows of electrical contacts are located, provided or hidden, at least partially, within the housing 105. As such, the second row of electrical contacts 120 will not contact the first row of connection pins on the edge connector. Likewise, the fourth row of electrical contacts 155 will not contact the third row of connection pins on the edge connector.

As the edge connector continues to move in the direction of the arrow 185, the edge connector pushes on the first contact point 140 of the first connector contact 135 and pushes on the first contact point 175 of the second connector contact 170. This causes the first connector contact 135 to rotate about an axis in a first direction (e.g., in the direction of arrow 190) and causes the second connector contact 170 to rotate about an axis in a second direction (e.g., in the direction of arrow 195).

As the first connector contact 135 rotates in the first direction, the second contact point 145 of the first connector contact 135 pushes on a back surface (or a top surface) of the second row of electrical contacts 120. This causes the second row of electrical contacts 120 to move from the second plane toward the first plane. Likewise, as the second connector contact 170 rotates in the second direction, the second contact point 145 of the second connector contact 170 pushes on a back surface (or a bottom surface) of the fourth row of electrical contacts 155 and causes the fourth row of electrical contacts 155 to move from the fourth plane toward the third plane.

When the edge connector is removed from the opening 110 (or is moved in an opposite direction from the arrow 185), the first connector contact 135 and the second connector contact 170 rotate back toward their initial position/orientation. As a result, the second row of electrical contacts 120 moves from the first plane back toward the second plane and the fourth row of electrical contacts 155 moves from the third plane back toward the fourth plane.

FIG. 1B illustrates a front cross-section view of the high density connector 100 shown and described with respect to FIG. 1A according to an example. As shown in FIG. 1B, when the second row of electrical contacts 120 is in the first position (e.g., in the second plane), the second row of electrical contacts 120 is positioned above the first row of electrical contacts 115 in the first plane.

Likewise, when the fourth row of electrical contacts 155 is in the first position (e.g., in the fourth plane), the fourth row of electrical contacts 155 is positioned below the third row of electrical contacts 150 in the third plane.

As also shown in FIG. 1B, the first connector contact 135 has a width that extends from a first side of the housing 105 of the high density connector 100 to a second side of the housing 105 of the high density connector 100. Likewise, the second connector contact 170 has a width that extends from the first side of the housing 105 of the high density connector 100 to the second side of the housing 105 of the high density connector 100. As such, the first contact point 140 of the first connector contact 135 is provided at or near an inner sidewall of the housing 105 and the first contact point 175 of the second connector contact 170 is positioned at or near the inner sidewall of the housing 105.

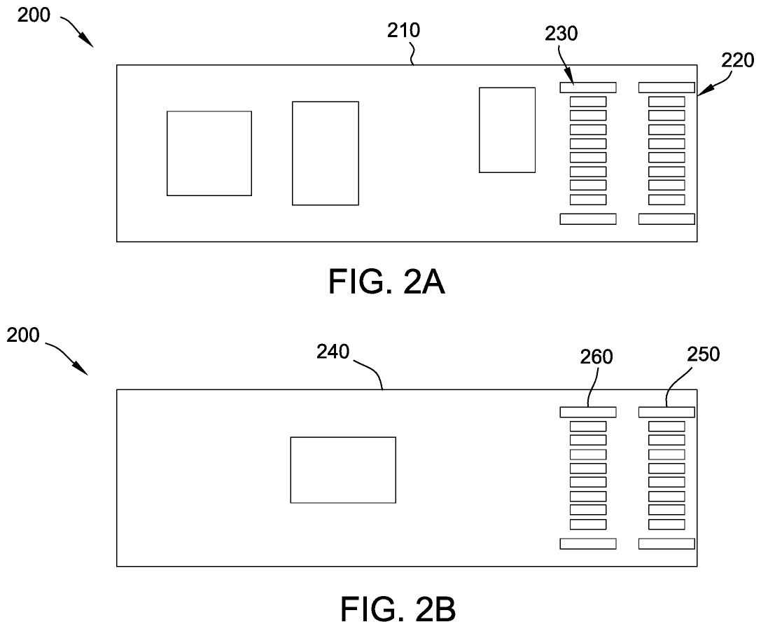

FIG. 2A illustrates a first side 210 of an electronic component 200 having a first row of connection pins 220 on an edge connecter and a second row of connection pins 230 on the edge connector according to an example. For example, the first row of connection pins 220 is positioned at a first location on the first side 210 of the electronic component 200 and the second row of connection pins 230 is positioned at a second location (e.g., behind the first row of connection pins 220) on the first side 210 of the electronic component.

The electronic component 200 also includes a third row of connection pins and a fourth row of connection pins on the opposite side. For example, FIG. 2B illustrates a second side 240 of the electronic component 200 of FIG. 2A having a third row of connection pins 250 on the edge connecter and a fourth row of connection pins 260 on the edge connector according to an example.

In an example, the electronic component 200 is removably coupleable with the high density connector 100 shown and described with respect to FIG. 1A-FIG. 1B. However, because the second row of electrical contacts 120 and the fourth row of electrical contacts 155 are hidden or positioned within the housing 105 (e.g., in the second plane and fourth plane respectively), there is little to no risk that the second row of electrical contacts 120 will contact the first row of connection pins 210 or that the fourth row of electrical contacts 155 will contact the third row of connection pins 250 when the electronic component 200 is inserted into the high density connector 100.

This prevents any shorts from occurring and reduces the number of times the first row of connection pins 220 and the third row of connection pins 250 are inserted into and past electrical contacts of the connector 200. As such, the durability and lifetime of the first row of connection pins 220 and the third row of connection pins 250 is increased when compared with current solutions (e.g., connectors without moveable connector contacts). Additionally, because there is little to no risk of shorts, various types of signals may be associated with different connection pins in the first row of connection pins 220 and/or the third row of connection pins 250.

FIG. 3A-FIG. 3C illustrate how an electronic component is received by a high density connector according to an example. In an example, the electronic component shown and described with respect to FIG. 3A-FIG. 3C is the electronic component 200 shown and described with respect to FIG. 2A. As such, similar reference numbers will be used. Likewise, the high density connector shown in FIG. 3A-FIG. 3C is the high density connector 100 shown and described with respect to FIG. 1A-FIG. 1B. As such, similar reference numbers will be used.

FIG. 3A illustrates a side cross-section view of the electronic component 200 of FIG. 2A being partially inserted into the high density connector 100 of FIG. 1A according to an example. As shown in FIG. 3A, because the second row of electrical contacts 120 and the fourth row of electrical contacts 155 are hidden or are otherwise contained (at least partially) within the housing 105, (e.g., the second row of electrical contacts 120 is in the second plane and the fourth row of electrical contacts 155 is in fourth plane), the second row of electrical contacts 120 will not contact the first row of connection pins 210 nor will the fourth row of electrical contacts 155 contact the third row of connection pins 250 when the electronic component 200 is inserted into the connector 100.

FIG. 3B illustrates a side cross-section view of the electronic component 200 of FIG. 2A being fully inserted into the high density connector 100 of FIG. 1A according to an example. As shown in FIG. 3B, when the electronic component 200 has been fully inserted into the high density connector 100, the edge connector (or a sidewall of the edge connector) contacts a first connector contact 135 and a second connector contact 170. Continued movement of the edge connector causes the first connector contact 135 to rotate about a first axis (or move from a first position/orientation to a second position/orientation). This movement also causes the second connector contact 170 to rotate about a second axis (or move from a first position/orientation to a second position/orientation).

As the first connector contact 135 rotates, the first connector contact 135 moves the second row of electrical contacts 120 from a first position (e.g., a position within the second plane and/or hidden within the housing 105) toward a second position (e.g., a position within the first plane and/or extending from the housing 105). When the second row of electrical contacts 120 is in the second position, the second row of electrical contacts 120 are electrically coupled to the second row of connection pins 230 of the electronic component 200. Additionally, the first row of electrical contacts 115 is electrically coupled to the first row of connection pins 220 of the electronic component 200.

Similarly, as the second connector contact 170 rotates, the second connector contact 170 moves the fourth row of electrical contacts 155 from a first position (e.g., a position within the fourth plane and/or hidden within the housing 105) toward a second position (e.g., a position within the third plane and/or extending from the housing 105). When the fourth row of electrical contacts 155 is in the second position, the fourth row of electrical contacts 120 is electrically coupled to the fourth row of connection pins 260 of the electronic component 200. Additionally, the third row of electrical contacts 150 is electrically coupled to the third row of connection pins 250 of the electronic component 200.

FIG. 3C illustrates a front cross-section view of the electronic component 200 of FIG. 2A being fully inserted into the high density connector 100 of FIG. 1A according to an example. As shown in FIG. 3C, when the sidewall of the electronic component 200 has contacted and moved the first connector contact 135 from a first position/orientation to the second position/orientation, the second row of electrical contacts 120 has moved from the first position to the second position. As such, the second row of electrical contacts 120 is electrically coupled to the second row of connection pins 230 of the electronic component 200. Additionally, the first row of electrical contacts 115 is electrically coupled to the first row of connection pins 220 of the electronic component 200.

Similarly, when the sidewall of the electronic component 200 has contacted and moved the second connector contact 170 from a first position/orientation to the second position/orientation, the fourth row of electrical contacts 155 has moved from the first position to the second position. As such, the fourth row of electrical contacts 155 is electrically coupled to the fourth row of connection pins 260 of the electronic component 200. Additionally, the third row of electrical contacts 150 is electrically coupled to the third row of connection pins 250 of the electronic component 200.

The description and illustration of one or more aspects provided in the present disclosure are not intended to limit or restrict the scope of the disclosure in any way. The aspects, examples, and details provided in this disclosure are considered sufficient to convey possession and enable others to make and use the best mode of claimed disclosure.

The claimed disclosure should not be construed as being limited to any aspect, example, or detail provided in this disclosure. Regardless of whether shown and described in combination or separately, the various features are intended to be selectively rearranged, included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Examples of the present disclosure describe a connector for an electronic device, comprising: a first row of electrical contacts located on a first plane of the connector; a second row of electrical contacts located on a second plane of the connector, the second plane being above the first plane; and a connector contact causing the second row of electrical contacts to move from the second plane toward the first plane in response to an edge connector of an electronic component contacting a surface of the connector contact. In an example, the connection also includes a housing defining an opening for receiving the edge connector of the electronic component, wherein the second row of electrical contacts is at least partially contained within the housing when the second row of electrical contacts is located on the second plane of the connector. In an example, the second row of electrical contacts extend from the housing as the second row of electrical contacts move from the second plane toward the first plane. In an example, the second row of electrical contacts contact a second row of connection pins on the edge connector of the electronic component when the second row of electric contacts move from the first plane to the second plane; and wherein the first row of electrical contacts contact a first row of connection pins on the edge connector of the electronic component when the second row of electrical contacts contact the second row of connection pins on the edge connector of the electronic component. In an example, the connector contact at least partially rotates about an axis in response to the edge connector of the electronic component contacting the surface of the connector contact. In an example, the second row of electrical contacts move toward the second plane in response to the edge connector of the electronic component being removed from the connector. In an example, the edge connector of the electronic component contacts a first surface of the connector contact and wherein a second surface of the connector contact pushes the second row of electrical contacts from the first second plane toward the first plane. In an example, the connector contact extends from a first side of a housing of the connector to a second side of the housing of the connector.

Examples also describe a high density connector, comprising: a housing defining an opening for receiving an edge connector of an electronic component, the edge connector having a first row of connection pins and a second row of connection pins behind the first row of connection pins; a first row of electrical contacts located at a first elevation within the housing; a second row of electrical contacts located at a second elevation within the housing, the second elevation being above the first elevation; and a connector contact provided within the housing and moveable between a first position and a second position, wherein the second row of electrical contacts moves from the second elevation toward the first elevation in response to the connector contact moving from the first position to the second position. In an example, the connector contact moves from the first position to the second position in response to the edge connector of the electronic component being inserted into the opening. In an example, the first row of electrical contacts are exposed within the opening and wherein the second row of electrical contacts are at least partially contained within the housing. In an example, the second row of electrical contact moves toward the second elevation from the first elevation in response to the connector contact moving from the second position toward the first position. In an example, the electrical contact rotates about an axis when moving from the first position toward the second position. In an example, the connector contact is a first connector contact and the connector further comprises: a third row of electrical contacts located at a third elevation within the housing; a fourth row of electrical contacts located at a fourth elevation within the housing, the fourth elevation being below the third elevation; and a second connector contact provided within the housing and moveable between a third position and a fourth position, wherein the fourth row of electrical contacts moves from the fourth elevation toward the third elevation in response to the second connector contact moving from the third position to the fourth position. In an example, the second row of connector contacts contact the second row of connection pins when the second row of connector contacts moves toward the first elevation. In an example, the first row of connection pins are uncontactable by the second row of connector contacts when the edge connector is inserted into the opening.

Additional examples describe a connector, comprising: a first row of contact means having a first elevation; a second row of contact means having a second elevation that is greater than the first elevation; and contact row pivoting means, the contact row pivoting means causing the second row of contact means to move from a first position to a second position in response to an edge connector of an electronic component being inserted into an opening defined by the connector. In an example, the contact row pivoting means pivots, at least partially, about an axis when moving the second row of contact means from the first position to the second position. In an example, the second row of contact means is at least partially contained within a housing of the connector when in the first position and at least partially extends from the housing when in the second position. In an example, a surface of the contact row pivoting means is located at a third elevation that is lower than the first elevation and the second elevation.

References to an element herein using a designation such as “first,” “second,” and so forth does not generally limit the quantity or order of those elements. Rather, these designations may be used as a method of distinguishing between two or more elements or instances of an element. Thus, reference to first and second elements does not mean that only two elements may be used or that the first element precedes the second element. Additionally, unless otherwise stated, a set of elements may include one or more elements.

Terminology in the form of “at least one of A, B, or C” or “A, B, C, or any combination thereof” used in the description or the claims means “A or B or C or any combination of these elements.” For example, this terminology may include A, or B, or C, or A and B, or A and C, or A and B and C, or 2A, or 2B, or 2C, or 2A and B, and so on. As an additional example, “at least one of: A, B, or C” is intended to cover A, B, C, A-B, A-C, B-C, and A-B-C, as well as multiples of the same members. Likewise, “at least one of: A, B, and C” is intended to cover A, B, C, A-B, A-C, B-C, and A-B-C, as well as multiples of the same members.

Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

What is claimed is:

1. A connector for an electronic device, comprising:
a first row of electrical contacts located on a first plane of the connector;
a second row of electrical contacts located on a second plane of the connector, the second plane being above the first plane; and
a connector contact causing the second row of electrical contacts to move from the second plane toward the first plane in response to an edge connector of an electronic component contacting a surface of the connector contact.

2. The connector of claim 1, further comprising a housing defining an opening for receiving the edge connector of the electronic component, wherein the second row of electrical contacts is at least partially contained within the housing when the second row of electrical contacts is located on the second plane of the connector.

3. The connector of claim 2, wherein the second row of electrical contacts extend from the housing as the second row of electrical contacts move from the second plane toward the first plane.

4. The connector of claim 1, wherein:
the second row of electrical contacts contact a second row of connection pins on the edge connector of the electronic component when the second row of electric contacts move from the first plane to the second plane; and
wherein the first row of electrical contacts contact a first row of connection pins on the edge connector of the electronic component when the second row of electrical contacts contact the second row of connection pins on the edge connector of the electronic component.

5. The connector of claim 1, wherein the connector contact at least partially rotates about an axis in response to the edge connector of the electronic component contacting the surface of the connector contact.

6. The connector of claim 1, wherein the second row of electrical contacts move toward the second plane in response to the edge connector of the electronic component being removed from the connector.

7. The connector of claim 1, wherein the edge connector of the electronic component contacts a first surface of the connector contact and wherein a second surface of the connector contact pushes the second row of electrical contacts from the first second plane toward the first plane.

8. The connector of claim 1, wherein the connector contact extends from a first side of a housing of the connector to a second side of the housing of the connector.

9. A high density connector, comprising:
a housing defining an opening for receiving an edge connector of an electronic component, the edge connector having a first row of connection pins and a second row of connection pins behind the first row of connection pins;
a first row of electrical contacts located at a first elevation within the housing;
a second row of electrical contacts located at a second elevation within the housing, the second elevation being above the first elevation; and
a connector contact provided within the housing and moveable between a first position and a second position, wherein the second row of electrical contacts moves from the second elevation toward the first elevation in response to the connector contact moving from the first position to the second position.

10. The connector of claim 9, wherein the connector contact moves from the first position to the second position in response to the edge connector of the electronic component being inserted into the opening.

11. The connector of claim 9, wherein the first row of electrical contacts are exposed within the opening and wherein the second row of electrical contacts are at least partially contained within the housing.

12. The connector of claim 9, wherein the second row of electrical contact moves toward the second elevation from the first elevation in response to the connector contact moving from the second position toward the first position.

13. The connector of claim 9, wherein the electrical contact rotates about an axis when moving from the first position toward the second position.

14. The connector of claim 9, wherein the connector contact is a first connector contact and the connector further comprises:
a third row of electrical contacts located at a third elevation within the housing;
a fourth row of electrical contacts located at a fourth elevation within the housing, the fourth elevation being below the third elevation; and
a second connector contact provided within the housing and moveable between a third position and a fourth position, wherein the fourth row of electrical contacts moves from the fourth elevation toward the third elevation in response to the second connector contact moving from the third position to the fourth position.

15. The connector of claim 9, wherein the second row of connector contacts contact the second row of connection pins when the second row of connector contacts moves toward the first elevation.

16. The connector of claim 9, wherein the first row of connection pins are uncontactable by the second row of connector contacts when the edge connector is inserted into the opening.

17. A connector, comprising:
a first row of contact means having a first elevation;
a second row of contact means having a second elevation that is greater than the first elevation; and
contact row pivoting means, the contact row pivoting means causing the second row of contact means to move from a first position to a second position in response to an edge connector of an electronic component being inserted into an opening defined by the connector.

18. The connector of claim 17, wherein the contact row pivoting means pivots, at least partially, about an axis when moving the second row of contact means from the first position to the second position.

19. The connector of claim 17, wherein the second row of contact means is at least partially contained within a housing of the connector when in the first position and at least partially extends from the housing when in the second position.

20. The connector of claim 17, wherein a surface of the contact row pivoting means is located at a third elevation that is lower than the first elevation and the second elevation.
